(19) United States
(12) Patent Application Publication
(10) Pub. No.: US 2018/0144424 A1
(43) Pub. Date: May 24, 2018

(54) METHOD AND SYSTEM FOR CONTENT PROCESSING TO QUERY MULTIPLE HEALTHCARE-RELATED KNOWLEDGE GRAPHS

(71) Applicant: YEN4KEN, INC., Princeton, NJ (US)

(72) Inventors: Archana Sahu, Pune (IN); Kaushik Baruah, Bangalore (IN); Sumit Negi, Bangalore (IN); Om D. Deshmukh, Bangalore (IN)

(21) Appl. No.: 15/355,085

(22) Filed: Nov. 18, 2016

(51) Int. Cl. G06Q 50/22; H04L 29/08; G06F 17/30

(52) U.S. Cl. CPC G06Q 50/22; H04L 67/10; G06F 17/30991; G06F 17/3053; G06F 17/30958; G06F 17/30867

(57) ABSTRACT

The disclosed embodiments illustrate methods and systems for querying multiple healthcare-related knowledge graphs. The method includes retrieving a set of healthcare-related response sub-graphs from a plurality of healthcare-related knowledge graphs based on a keyword-based query. The method further includes generating a first set of healthcare-related ranked sub-graphs corresponding to the plurality of healthcare-related knowledge graphs. The method further includes generating a set of healthcare-related connected sub-graphs, based on at least healthcare-related ranked sub-graphs in the plurality of healthcare-related knowledge graphs. The method further includes generating a second set of healthcare-related ranked sub-graphs based on at least a ranking of healthcare-related connected sub-graphs in the set of healthcare-related connected sub-graphs. The method further includes rendering a queried response, based on a selection of one or more of the generated second set of healthcare-related ranked sub-graphs, on a user interface displayed on a display screen of the requestor-computing device.

### TECHNICAL FIELD

The presently disclosed embodiments are related, in general, to content processing. More particularly, the presently disclosed embodiments are related to a method and a system for content processing to query multiple healthcare-related knowledge graphs.

### BACKGROUND

Large healthcare-related knowledge bases (also referred to as healthcare-related knowledge graphs), consisting of entities and relationships between the entities, have become vital sources of healthcare-related information for many applications. For example, a user may query a healthcare-related knowledge graph, on diseases, their symptoms, and prescribed procedures and medications, to in order to obtain a desired response pertaining to a particular disease. However, querying these knowledge bases is typically done using structured queries, such as SPARQL, which require some amount of expertise from users who may want to query the healthcare-related knowledge graphs. Furthermore, it may not be assured that the desired response, obtained in response to a structured query from the healthcare-related knowledge graph, is a complete answer corresponding to the structured query. For example, if the user further wishes to know about information associated with hospitals that specialize in treating the particular disease, then querying the healthcare-related knowledge graph may not provide such information. In such a case, the user may have to query another healthcare-related knowledge graph that can provide the information associated with the hospitals. Therefore, there is a need for an improved method for querying the healthcare-related knowledge graphs that is more user friendly as well as provide more accurate and effective responses.

Further, limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method for content processing, by a computing server, to query multiple healthcare-related knowledge graphs. The method includes retrieving, by a graph processor at the computing server, a set of healthcare-related response sub-graphs from each of a plurality of healthcare-related knowledge graphs. The plurality of healthcare-related knowledge graphs are communicatively coupled with one or more medical databases over a communication network. The set of healthcare-related response sub-graphs may be retrieved from each of the plurality of healthcare-related knowledge graphs based on one or more healthcare-related keywords in a keyword-based query. The keyword-based query is received from a requestor-computing device over the communication network. The method further includes generating, by a rank generating processor at the computing server, a first set of healthcare-related ranked sub-graphs corresponding to each of the plurality of healthcare-related knowledge graphs. The method further includes generating, by a graph generating processor at the computing server, a set of healthcare-related connected sub-graphs. Each healthcare-related connected sub-graph in the set of healthcare-related connected sub-graphs may be generated based on at least a healthcare-related ranked sub-graph in the first set of healthcare-related ranked sub-graphs associated with the plurality of healthcare-related knowledge graphs. The method further includes generating, by the rank generating processor, a second set of healthcare-related ranked sub-graphs based on at least a ranking of healthcare-related connected sub-graphs in the set of healthcare-related connected sub-graphs. The method further includes rendering, by a processor, a queried response, based on a selection of one or more of the generated second set of healthcare-related ranked sub-graphs, on a user interface displayed on a display screen of the requestor-computing device.

According to embodiments illustrated herein, there is provided a system for content processing to query multiple healthcare-related knowledge graphs. The system includes a graph processor that is configured to retrieve a set of healthcare-related response sub-graphs from each of a plurality of healthcare-related knowledge graphs. The plurality of healthcare-related knowledge graphs are communicatively coupled with one or more medical databases over a communication network. The set of healthcare-related response sub-graphs may be retrieved from each of the plurality of healthcare-related knowledge graphs based on one or more healthcare-related keywords in a keyword-based query. The keyword-based query is received from a requestor-computing device over the communication network. The system further includes a rank generating processor that is configured to generate a first set of healthcare-related ranked sub-graphs corresponding to each of the plurality of healthcare-related knowledge graphs. The system further includes a graph generating processor that is configured to generate a set of healthcare-related connected sub-graphs. Each healthcare-related connected sub-graph in the set of connected sub-graphs may be generated based on at least a healthcare-related ranked sub-graph in the first set of healthcare-related ranked sub-graphs associated with the plurality of healthcare-related knowledge graphs. Thereafter, the rank generating processor is further configured to generate a second set of healthcare-related ranked sub-graphs based on at least a ranking of healthcare-related connected sub-graphs in the set of healthcare-related connected sub-graphs. The system further includes a processor that is configured to render a queried response, based on a selection of one or more of the generated second set of healthcare-related ranked sub-graphs, on a user interface displayed on a display screen of the requestor-computing device.

According to embodiments illustrated herein, there is provided a method for content processing, by a computing server, to query multiple knowledge graphs. The method includes retrieving, by a graph processor at the computing server, a set of response sub-graphs from each of a plurality of knowledge graphs based on one or more keywords in a keyword-based query. The keyword-based query is received from a requestor-computing device over a communication network. The method further includes generating, by a rank generating processor at the computing server, a first set of ranked sub-graphs corresponding to each of the plurality of knowledge graphs. The method further includes generating, by a graph generating processor at the computing server, a set of connected sub-graphs. A connected sub-graph in the set of connected sub-graphs is generated based on at least a ranked sub-graph in the first set of ranked sub-graphs associated with the plurality of knowledge graphs. The method further includes generating, by the rank generating processor, a second set of ranked sub-graphs based on at least a ranking of connected sub-graphs in the set of connected sub-graphs. The method further includes rendering, by a processor, a queried response, based on a selection of one or more of the generated second set of ranked sub-graphs, on a user interface displayed on a display screen of the requestor-computing device.

According to embodiments illustrated herein, there is provided a system for content processing to query multiple knowledge graphs. The system includes a graph processor configured to retrieve a set of response sub-graphs from each of a plurality of knowledge graphs based on one or more keywords in a keyword-based query. The keyword-based query is received from a requestor-computing device over a communication network. The system further a rank generating processor configured to generate a first set of ranked sub-graphs corresponding to each of the plurality of knowledge graphs. The system further includes a graph generating processor configured to generate a set of connected sub-graphs. A connected sub-graph in the set of connected sub-graphs is generated based on at least a ranked sub-graph in the first set of ranked sub-graphs associated with the plurality of knowledge graphs. The system further includes generation of a second set of ranked sub-graphs by the rank generating processor, based on at least a ranking of connected sub-graphs in the set of connected sub-graphs. The system further includes a processor configured to render a queried response, based on a selection of one or more of the generated second set of ranked sub-graphs, on a user interface displayed on a display screen of the requestor-computing device.

According to embodiment illustrated herein, there is provided a computer program product for use with a computer. The computer program product includes a non-transitory computer readable medium. The non-transitory computer readable medium stores a computer program code for content processing to query multiple knowledge graphs. The computer program code is executable by one or more processors to retrieve a set of response sub-graphs from each of a plurality of knowledge graphs based on one or more keywords in a keyword-based query. The keyword-based query is received from a requestor-computing device over a communication network. The computer program code is further executable by the one or more processors to generate a first set of ranked sub-graphs corresponding to each of the plurality of knowledge graphs. The computer program code is further executable by the one or more processors to generate a set of connected sub-graphs. A connected sub-graph in the set of connected sub-graphs is generated based on at least a ranked sub-graph in the first set of ranked sub-graphs associated with the plurality of knowledge graphs. The computer program code is further executable by the one or more processors to generate a second set of ranked sub-graphs based on at least a ranking of connected sub-graphs in the set of connected sub-graphs. The computer program code is further executable by the one or more processors to render a queried response, based on a selection of one or more of the generated second set of ranked sub-graphs, on a user interface displayed on a display screen of the requestor-computing device.

### BRIEF DESCRIPTION OF DRAWINGS

The accompanying drawings illustrate the various embodiments of systems, methods, and other aspects of the disclosure. A person with ordinary skill in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment in which various embodiments can be implemented, in accordance with at least one embodiment;

FIG. 2 is a block diagram that illustrates a system for content processing to query multiple knowledge graphs, in accordance with at least one embodiment;

FIG. 3 is a flowchart that illustrates a method for content processing to query multiple healthcare-related knowledge graphs, in accordance with at least one embodiment;

FIG. 4 is a block diagram that illustrates an exemplary workflow for content processing to query multiple knowledge graphs, in accordance with an embodiment; and

FIGS. 5A, 5B, and 5C are line-node diagrams that illustrates a generation of a healthcare-related connected sub-graph, in accordance with an embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

A “computing device” refers to a computer, a device (that includes one or more processors/microcontrollers and/or any other electronic components), or a system (that performs one or more operations according to one or more sets of programming instructions, code, or algorithms) associated with an individual. In one exemplary scenario, the individual (e.g., a requestor) may utilize the computing device to transmit a request to query one or more knowledge graphs. The request may comprise at least a search string (e.g., a keyword-based query). Further, the individual may utilize the computing device to view one or more responses corresponding to the transmitted request. Examples of the computing device may include, but are not limited to, a desktop computer, a laptop, a personal digital assistant (PDA), a mobile device, a smartphone, and a tablet computer (e.g., iPad® and Samsung Galaxy The).

A “request” refers to a message, an instruction, or a query that is indicative of initiating a task or a process to achieve desired response. For example, an individual may raise the request, transmitted to a computing server, to query multiple knowledge graphs to obtain the desired response.

A “knowledge graph” refers to a knowledge base that may be used to store structured and unstructured information. In an embodiment, the information may be stored in form of one or more graphs. Further, each graph in the one or more graphs may comprise one or more nodes and one or more edges. For example, the knowledge graph may correspond to Yago®, Google KG®, Freebase®, and so on. Further, the knowledge graph may be associated with one or more domains, such medical domain, political domain, sports domain, entertainment domain, and so on.

A “graph” in a knowledge graph refers to a pictorial representation of information stored in the knowledge graph. The graph may comprise at least a plurality of nodes and one or more edges. In an embodiment, a node in the plurality of nodes may correspond to an entity, for example, a name of a disease, one or more symptoms of the disease, and/or the like. In an embodiment, an edge (between two nodes) in the one or more edges may correspond to a relationship between two entities that are associated with the two nodes. For example, “Barack Obama” and “United States of America” are entities that are linked with the relation “isPresidentOf”.

A “keyword-based query” refers to a search string that may be utilized to query one or more search engines, such as knowledge graphs, (e.g., Google KG®), to obtain one or more desired responses. In an embodiment, the keyword-based query may comprise one or more characters, words, or phrases that are of interest to a user. The one or more characters, words, or phrases may be associated with one or more domain of interests to a user. For example, the one or more characters, words, or phrases may be associated with a medical domain, a political domain, a sports domain, an entertainment domain, and a combination thereof.

A “set of response sub-graphs” refers to a set of graphs (or sub-graphs) that is obtained or retrieved from a knowledge graph in response to a query. For example, a set of healthcare-related response sub-graphs may be retrieved from a healthcare-related knowledge graph in response to a query comprising one or more healthcare-related keywords. In an embodiment, each of the set of response sub-graphs may be associated with one or more words or phrases that correspond to the query.

A “first set of ranked sub-graphs” refers to a set of response sub-graphs, retrieved from a knowledge graph in response to a query, comprising response sub-graphs in a definite order. The response sub-graphs in the retrieved set of response sub-graphs may be arranged in the definite order, based on at least content and structure information associated with each of the response sub-graphs, to obtain the first set of ranked sub-graphs. For example, healthcare-related response sub-graphs, retrieved from a healthcare-related knowledge graph, may be ranked based on at least content and structure information associated with the healthcare-related response sub-graphs to obtain a first set of healthcare-related ranked sub-graphs.

A “connected sub-graph” refers to a sub-graph that may be generated based on joining of at least two sub-graphs in a plurality of sub-graphs. In an embodiment, the at least two sub-graphs in the plurality of sub-graphs are associated with at least two knowledge graphs. In an embodiment, one or more nodes of each of at least two sub-graphs in the plurality of sub-graphs are joined or connected with each other to generate the connected sub-graph.

A “second set of ranked sub-graphs” refers to a set of connected sub-graphs that are arranged in a definite order. In an embodiment, connected sub-graphs in the set of connected sub-graphs may be arranged in the definite order based on at least an aggregated ranking of a third set of ranked sub-graphs, a fourth set of ranked sub-graphs, and a fifth set of ranked sub-graphs. In an embodiment, the third set of ranked sub-graphs may be generated based on the ranking of connected sub-graphs in the set of connected sub-graphs based on at least the keyword-based query. In an embodiment, the fourth set of ranked sub-graphs may be generated based on the ranking of the connected sub-graphs based on at least content and structure information associated with each of the connected sub-graphs. In an embodiment, the fifth set of ranked sub-graphs may be generated based on the ranking of connected sub-graphs based on at least an alignment quality score of each of the connected sub-graphs. The alignment quality score of a connected sub-graph is determined based on at least a count of connected nodes and/or connected edges in the connected sub-graph.

A “degree of alignment” refers to a score that defines an alignment of a ranked sub-graph in a first set of ranked sub-graphs associated with a knowledge graph in said plurality of knowledge graphs with the ranked sub-graph in the first set of ranked sub-graphs associated with one or more remaining knowledge graphs in the plurality of knowledge graphs. In an embodiment, the degree of alignment may be determined based on at least degree of similarities between each pair of nodes. In an embodiment, a first node in each pair of nodes is associated with the ranked sub-graph in the first set of ranked sub-graphs associated with the knowledge graph in the plurality of knowledge graphs. In an embodiment, a second node in each pair of nodes is associated with the ranked sub-graph in the first set of ranked sub-graphs associated with the one or more remaining knowledge graphs in the plurality of knowledge graphs.

A “user interface (UI)” refers to an interface or a platform that may facilitate an individual to interact with an associated computing device, such as a computer, a laptop, or a smartphone. The individual may utilize various input mediums to interact with the UI such as, but are not limited to, a keypad, mouse, joystick, any touch-sensitive medium (e.g., a touch-screen or touch sensitive pad), voice recognition, gestures, video recognition, and so forth. Hereinafter, the term “UI” is interchangeably referred to as “GUI”.

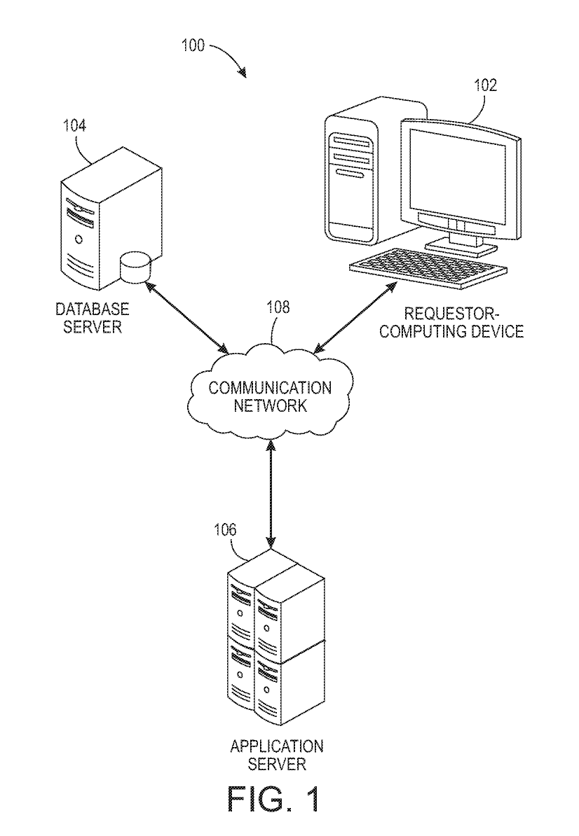

FIG. 1 is a block diagram of a system environment in which various embodiments of a method and a system for content processing to query multiple knowledge graphs may be implemented. With reference to FIG. 1, there is shown a system environment 100 that includes a requestor-computing device 102, a database server 104, and an application server 106. The requestor-computing device 102, the database server 104, and the application server 106 are communicatively coupled with each other over one or more communication networks, such as a communication network 108. For simplicity, FIG. 1 shows one requestor-computing device, such as the requestor-computing device 102, one database server, such as the database server 104, and one application server, such as the application server 106. However, it will be apparent to a person having ordinary skill in the art that the disclosed embodiments may also be implemented using multiple requestor-computing devices, multiple database servers, and multiple application servers, without deviating from the scope of the disclosure.

The requestor-computing device 102 may refer to a computing device (associated with a requestor) that may be communicatively coupled to the communication network 108. The requestor may correspond to an individual who may utilize the requestor-computing device 102 to communicate with one or more computing servers, such as the database server 104 or the application server 106, over the communication network 110. In an embodiment, the requestor may utilize the requestor-computing device 102 to transmit a request, pertaining to the content processing, to the one or more computing servers, such as the database server 104 or the application server 106, over the communication network 108. The transmitted request may comprise at least a search string or query (e.g., a keyword-based query) for querying one or more knowledge graphs. The keyword-based query may comprise at least one or more keywords that are of interest to the requestor. For example, the transmitted request may comprise one or more healthcare-related keywords for querying one or more healthcare-related knowledge graphs. Further, in an embodiment, the requestor may utilize the requestor-computing device 102 to transmit one or more preferences for the one or more knowledge graphs to the one or more computing servers, such as the database server 104 or the application server 106, over the communication network 108.

The requestor-computing device 102 may include one or more processors in communication with one or more memory units. Further, in an embodiment, the one or more processors may be operable to execute one or more sets of computer-readable code, instructions, programs, or algorithms, stored in the one or more memory units, to perform one or more operations. The requestor-computing device 102 may further include a display screen that may be configured to display one or more GUIs rendered by the application server 106 over the communication network 108. For example, the application server 106 may render a GUI displaying one or more queried responses in response to the received keyword-based query.

Examples of the requestor-computing device 102 may include, but are not limited to, a personal computer, a laptop, a PDA, a mobile device, a tablet, or any other computing devices.

The database server 104 may refer to a computing device or a storage device that may be communicatively coupled to the communication network 108. In an embodiment, the database server 104 may be configured to perform one or more database operations. Examples of the one or more database operations may include receiving/transmitting one or more queries, requests, or content from/to one or more computing devices, such as the requestor-computing device 102 or the application server 106, over the communication network 108. The one or more database operations may further include processing and storing the one or more queries, requests, or content.

In an embodiment, the database server 104 may be communicatively coupled with the one or more knowledge graphs over the communication network 108. The one or more knowledge graphs may be associated with one or more domains, such as health, sports, politics, entertainment, education, and so on. Further, the one or more knowledge graphs are communicatively coupled with one or more associated databases over the communication network 108. For example, a healthcare-related knowledge graph may be communicatively coupled with a medical database over the communication network 108.

Further, based on the request received from the requestor-computing device 102 or the application server 106, the database server 104 may query at least a plurality of knowledge graphs that includes the one or more knowledge graphs over the communication network 108. Based on the querying of the plurality of knowledge graphs, the database server 104 may extract a set of response sub-graphs from each of the plurality of knowledge graphs. In an embodiment, the database server 104 may store the extracted set of response sub-graphs. Further, in an embodiment, the database server 104 may transmit the extracted set of response sub-graphs to the application server 106 over the communication network 108. Further, in an embodiment, the database server 104 may be configured to store the one or more queried responses transmitted by the application server 106 over the communication network 108.

Further, in an embodiment, the database server 104 may store one or more sets of instructions, code, scripts, or programs that may be retrieved by the application server 106 to perform one or more operations. For querying the database server 104, one or more querying languages, such as but not limited to, SQL, QUEL, and DMX, may be utilized. In an embodiment, the database server 104 may be realized through various technologies such as, but not limited to, Microsoft® SQL Server, Oracle®, IBM DB2®, Microsoft Access®, PostgreSQL®, MySQL® and SQLite®, MongoDB®, and/or the like.

The application server 106 may refer to a computing device or a software framework hosting an application or a software service that may be communicatively coupled to the communication network 108. In an embodiment, the application server 106 may be implemented to execute procedures such as, but not limited to, the one or more sets of programs, instructions, code, routines, or scripts stored in one or more memory units for supporting the hosted application or the software service. In an embodiment, the hosted application or the software service may be configured to perform the one or more operations of the application server 106.

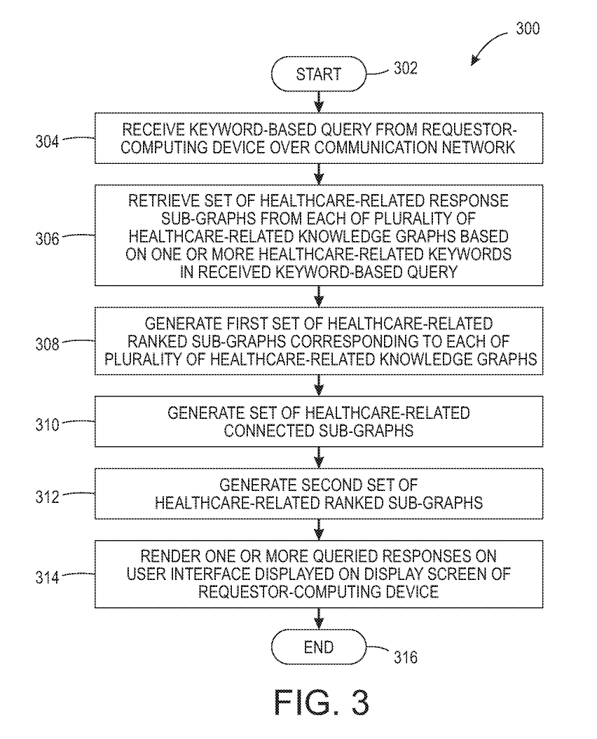

In an embodiment, the application server 106 may be configured to receive the request comprising the keyword-based query from the requestor-computing device 102 over the communication network 108. The keyword-based query may comprise one or more keywords that are of interest to the requestor associated with the requestor-computing device 102. For example, the keyword-based query may comprise the one or more healthcare-related keywords for querying a plurality healthcare-related knowledge graphs. Further, based on the received request, the application server 106 may transmit the query to the database server 104 to extract the set of response sub-graphs from each of the plurality of knowledge graphs. In one embodiment, the query may correspond to the keyword-based query received from the requestor-computing device 102. In another embodiment, the application server 106 may be configured to generate the query based on the one or more keywords in the received keyword-based query. Thereafter, in response to the transmitted query to the database server 104, the application server 106 may receive the extracted set of response sub-graphs pertaining to each of the plurality of knowledge graphs from the database server 104 over the communication network 108. In another embodiment, the application server 106 may extract or retrieve the set of response sub-graphs from each of the plurality of knowledge graphs over the communication network 108 based on the received keyword-based query. For example, the application server 106 may transmit the query, comprising the one or more healthcare-related keywords, to the plurality of healthcare-related knowledge graphs to extract or retrieve a set of healthcare-related response sub-graphs. The extraction of the set of healthcare-related response sub-graphs has been described later in detail in conjunction with FIG. 3.

Further, in an embodiment, the application server 106 may be configured to generate a first set of ranked sub-graphs corresponding to each of the plurality of knowledge graphs. For example, the application server 106 may generate a first set of healthcare-related ranked sub-graphs corresponding to each of the plurality of healthcare-related knowledge graphs. The generation of the first set of healthcare-related ranked sub-graphs has been described later in detail in conjunction with FIG. 3. Further, in an embodiment, the application server 106 may be configured to generate a set of connected sub-graphs. In an embodiment, a connected sub-graph that corresponds to the set of connected sub-graphs may be generated based on at least a ranked sub-graph in the first set of ranked sub-graphs associated with at least two knowledge graphs in the plurality of knowledge graphs. For example, the application server 106 may generate a set of healthcare-related connected sub-graphs based on at least one or more healthcare-related ranked sub-graphs in the first set of healthcare-related ranked sub-graphs associated with at least two healthcare-related knowledge graphs in the plurality of healthcare-related knowledge graphs. The generation of the set of healthcare-related connected sub-graphs has been described later in detail in conjunction with FIG. 3. Further, in an embodiment, the application server 106 may be configured to generate a second set of ranked sub-graphs based on at least the ranking of connected sub-graphs in the set of connected sub-graphs. For example, the application server 106 may be configured to generate a second set of healthcare-related ranked sub-graphs based on at least the ranking of healthcare-related connected sub-graphs in the set of healthcare-related connected sub-graphs. The generation of the second set of healthcare-related ranked sub-graphs has been described later in detail in conjunction with FIG. 3.

Further, in an embodiment, the application server 106 may select the one or more queried responses, in response to the received keyword-based query, from the second set of ranked sub-graphs based on a pre-defined criteria. In an embodiment, the selection of the one or more queried responses may correspond to the selection of one or more connected sub-graphs from the second set of ranked sub-graphs. For example, the application server 106 may select the one or more queried responses, in response to the received keyword-based query, from the second set of healthcare-related ranked sub-graphs. The selection of the one or more queried responses has been described later in detail in conjunction with FIG. 3. Thereafter, the application server 106 may render the selected one or more queried responses on the GUI that is displayed on the display screen of the requestor-computing device 102. Further, in an embodiment, the application server 106 may store the first set of ranked sub-graphs, the second set of ranked sub-graphs, the set of connected sub-graphs, and the one or more queried responses in a storage device, such as the database server 104. For example, the application server 106 may store the first set of healthcare-related ranked sub-graphs, the second set of healthcare-related ranked sub-graphs, the set of healthcare-related connected sub-graphs, and the one or more queried responses in the database server 104.

The application server 106 may be realized through various types of application servers such as, but not limited to, a Java application server, a .NET framework application server, a Base4 application server, a PHP framework application server, or any other application server framework.

A person having ordinary skill in the art will understand that the scope of the disclosure is not limited to the database server 104 as a separate entity. In an embodiment, the one or more functionalities of the database server 104 may be integrated into the application server 106, or vice-versa, without deviating from the scope of the disclosure.

The communication network 108 may include a medium through which the one or more computing devices, such as the requestor-computing device 102, and the one or more computing servers, such as the database server 104 and the application server 106, may communicate with each other. Examples of the communication network 108 may include, but are not limited to, the Internet, a cloud network, a Wireless Fidelity (Wi-Fi) network, a Wireless Local Area Network (WLAN), a Local Area Network (LAN), a wireless personal area network (WPAN), a Wireless Local Area Network (WLAN), a wireless wide area network (WWAN), a cloud network, a Long Term Evolution (LTE) network, a plain old telephone service (POTS), and/or a Metropolitan Area Network (MAN). Various devices in the system environment 100 may be configured to connect to the communication network 108, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, such as Long Term Evolution (LTE), Light Fidelity (Li-Fi), and/or other cellular communication protocols or Bluetooth (BT) communication protocols.

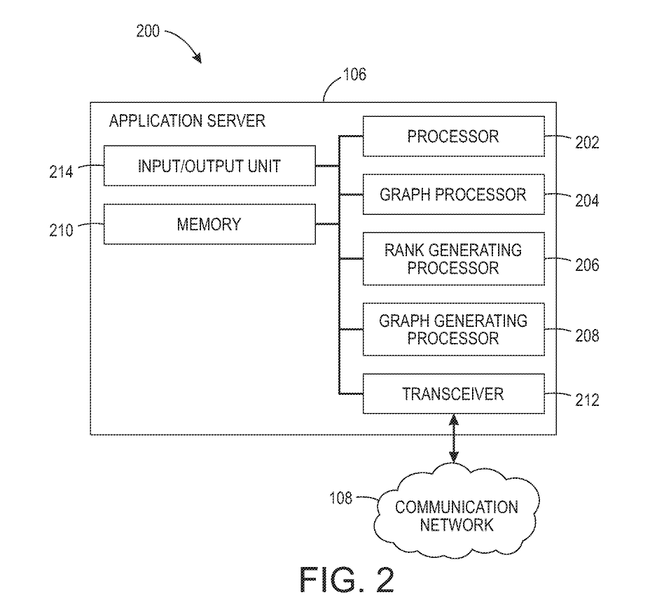

FIG. 2 is a block diagram that illustrates a system for content processing to query multiple knowledge graphs, in accordance with at least one embodiment. With reference to FIG. 2, there is shown a system 200 that may include one or more processors, such as a processor 202, one or more graph processors, such as a graph processor 204, one or more rank generating processors, such as a rank generating processor 206, one or more graph generating processors, such as a graph generating processor 208, one or more memory units, such as a memory 210, one or more transceivers, such as a transceiver 212, and one or more input/output (I/O) units, such as an I/O unit 214.

The system 200 may correspond to a computing device, such as the requestor-computing device 102, or a computing server, such as the application server 106, without departing from the scope of the disclosure. However, for the purpose of the ongoing description, the system 200 corresponds to the application server 106.

The processor 202 comprises suitable logic, circuitry, interfaces, and/or code that may be configured to execute one or more sets of instructions, programs, or algorithms stored in the memory 210 to perform the one or more operations. For example, the processor 202 may be configured to render the GUI on the display screen of the requestor-computing device 102 over the communication network 108. The rendered GUI may be configured to display the one or more queried responses comprising one or more of the set of connected sub-graphs that are selected from the second set of ranked sub-graphs. In an embodiment, the processor 202 may be communicatively coupled to the graph processor 204, the rank generating processor 206, the graph generating processor 208, the memory 210, the transceiver 212, and the I/O unit 214. The processor 202 may be implemented based on a number of processor technologies known in the art. Examples of the processor 202 may include, but not limited to, an X86-based processor, a Reduced Instruction Set Computing (RISC) processor, an Application-Specific Integrated Circuit (ASIC) processor, and a Complex Instruction Set Computing (CISC) processor.

The graph processor 204 comprises suitable logic, circuitry, interfaces, and/or code that may be configured to execute the one or more sets of instructions, programs, code, or algorithms stored in the memory 210 to perform the one or more operations. In an embodiment, the graph processor 204 may be configured to extract or retrieve the set of response sub-graphs from the database server 104 in response to the received keyword-based query. In another embodiment, the graph processor 204 may be configured to extract or retrieve the set of response sub-graphs from the plurality of knowledge graphs in response to the received keyword-based query. In an embodiment, the graph processor 204 may be communicatively coupled to the processor 202, the rank generating processor 206, the graph generating processor 208, the memory 210, the transceiver 212, and the I/O unit 214. The graph processor 204 may be implemented based on a number of processor technologies known in the art. For examples, the graph processor 204 may be implemented using one or more of, but not limited to, an X86-based processor, a RISC processor, an ASIC processor, a CISC processor, and/or other processor.

The rank generating processor 206 comprises suitable logic, circuitry, interfaces, and/or code that may be configured to execute the one or more sets of instructions, programs, or algorithms stored in the memory 210 to perform the one or more operations. For example, the rank generating processor 206 may be configured to generate the first set of ranked sub-graphs corresponding to each of the plurality of knowledge graphs. Further, the rank generating processor 206 may be configured to generate the second set of ranked sub-graphs, the third set of ranked sub-graphs, the fourth set of ranked sub-graphs, and the fifth set of ranked sub-graphs. The rank generating processor 206 may be communicatively coupled to the processor 202, the graph processor 204, the graph generating processor 208, the memory 210, the transceiver 212, and the I/O unit 214. The rank generating processor 206 may be implemented based on a number of processor technologies known in the art. For example, the rank generating processor 206 may be implemented using one or more of, but not limited to, an X86-based processor, a RISC processor, an ASIC processor, a CISC processor, and/or other processor.

The graph generating processor 208 comprises suitable logic, circuitry, interfaces, and/or code that may be configured to execute the one or more sets of instructions, programs, or algorithms stored in the memory 210 to perform the one or more operations. For example, the graph generating processor 208 may be configured to generate the set of connected sub-graphs. In an embodiment, the connected sub-graph that corresponds to the set of connected sub-graphs is generated based on at least the ranked sub-graph in the first set of ranked sub-graphs associated with at least two of the plurality of knowledge graphs. The graph generating processor 208 may be communicatively coupled to the processor 202, the graph processor 204, the rank generating processor 206, the memory 210, the transceiver 212, and the I/O unit 214. The graph generating processor 208 may be implemented based on a number of processor technologies known in the art. For example, the graph generating processor 208 may be implemented using one or more of, but not limited to, an X86-based processor, a RISC processor, an ASIC processor, a CISC processor, and/or other processor.

The memory 210 may be operable to store one or more machine code, and/or computer programs having at least one code section executable by the processor 202, the graph processor 204, the rank generating processor 206, the graph generating processor 208, the transceiver 212, and/or the I/O unit 214. The memory 210 may store the one or more sets of instructions, programs, code, or algorithms that are executed by the processor 202, the graph processor 204, the rank generating processor 206, the graph generating processor 208, the transceiver 212, and/or the I/O unit 214 to perform the respective one or more operations. In an embodiment, the memory 210 may comprise one or more buffer units (not shown) that may be configured to store the received keyword-based query, the extracted set of response sub-graphs, the first set of ranked sub-graphs, the second set of ranked sub-graphs, and the set of connected sub-graphs. Some of the commonly known memory implementations include, but are not limited to, a random access memory (RAM), a read-only memory (ROM), a hard disk drive (HDD), and a secure digital (SD) card. In an embodiment, the memory 210 may include the one or more machine code and/or computer programs that are executable by the processor 202, the graph processor 204, the rank generating processor 206, the graph generating processor 208, the transceiver 212, and/or the I/O unit 214 to perform the one or more specific operations. It will be apparent to a person having ordinary skill in the art that the one or more instructions stored in the memory 210 enables the hardware of the system 200 to perform the one or more operations.

The transceiver 212 comprises suitable logic, circuitry, interfaces, and/or code that may be configured to receive/transmit the one or more queries, requests, content, or other information from/to one or more computing devices or servers (e.g., the requestor-computing device 102, the database server 104, or the application server 106) over the communication network 108. The transceiver 212 may implement one or more known technologies to support wired or wireless communication with the communication network 108. In an embodiment, the transceiver 212 may include circuitry, such as but not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 212 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Light Fidelity (Li-Fi), Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The I/O unit 214 comprises suitable logic, circuitry, interfaces, and/or code that may be operable to facilitate the requestor to input one or more input parameters. For example, the requestor may utilize the I/O unit 214 to input the request pertaining to the content processing for querying the multiple knowledge graphs. The requestor may further utilize the I/O unit 214 to define one or more constant parameters. The I/O unit 214 may be operable to communicate with the processor 202, the graph processor 204, the rank generating processor 206, the graph generating processor 208, and/or the transceiver 212. Further, in an embodiment, the I/O unit 214, in conjunction with the processor 202 and the transceiver 212, may be operable to provide the one or more queried responses to the requestor. In an embodiment, the one or more queried responses may be rendered on the GUI in various forms, such as either in an audio form, a video form, a graphical form, or a text form. Examples of the input devices may include, but are not limited to, a touch screen, a keyboard, a mouse, a joystick, a microphone, a camera, a motion sensor, a light sensor, and/or a docking station. Examples of the output devices may include, but are not limited to, a speaker system and a display screen.

FIG. 3 is a flowchart that illustrates a method for content processing to query multiple healthcare-related knowledge graphs, in accordance with at least one embodiment. With reference to FIG. 3, there is shown a flowchart 300 that is described in conjunction with FIG. 1 and FIG. 2. The method starts at step 302 and proceeds to step 304.

At step 304, the keyword-based query is received from the requestor-computing device 102 over the communication network 108. In an embodiment, the transceiver 212 may be configured to receive the keyword-based query from the requestor-computing device 102 over the communication network 108. The keyword-based query may comprise the one or more healthcare-related keywords that are of interest to the requestor associated with the requestor-computing device 102.

Prior to the receiving of the keyword-based query, the requestor may utilize the requestor-computing device 102 to connect over the communication network 108. Thereafter, the requestor may utilize the requestor-computing device 102 to transmit the request, pertaining to the content processing, to the transceiver 212 over the communication network 108. The transmitted request may comprise at least the keyword-based query comprising at least the one or more healthcare-related keywords. For example, the transmitted request may correspond to “Laparoscopy Surgery Delhi”. The transmitted request may further comprise the one or more preferences for the one or more healthcare-related knowledge graphs. Further, in an embodiment, the requestor may utilize the requestor-computing device 102 to transmit the one or more constant parameters. After receiving the request, the processor 202, in conjunction with the transceiver 212, may store the received request and the keyword-based query in the storage device, such as the memory 210 or the database server 104.

At step 306, the set of healthcare-related response sub-graphs is retrieved from each of the plurality of healthcare-related knowledge graphs based on at least the one or more healthcare-related keywords in the received keyword-based query. In an embodiment, the graph processor 204 may be configured to retrieve the set of healthcare-related response sub-graphs from each of the plurality of healthcare-related knowledge graphs based on the one or more healthcare-related keywords in the received keyword-based query. In an embodiment, each of the set of healthcare-related response sub-graphs may include a plurality of nodes and one or more edges. In an embodiment, each of the plurality of nodes may correspond to an entity, such as, but not limited to, a name of an individual, place, animal, bird, plant, organization, and/or so on. For example, one or more entities in a healthcare-related response sub-graph may be associated with the one or more healthcare-related keywords. In an embodiment, each of the one or more edges between two nodes may be representative of a relationship between two entities that are associated with the two nodes. For example, “Delhi” and “AIIMS” are two entities that are linked with a relation “hasHospital”.

Prior to retrieving the set of healthcare-related response sub-graphs from the plurality of healthcare-related knowledge graphs, the graph processor 204 may be configured to query the plurality of healthcare-related knowledge graphs over the communication network 108. The graph processor 204 may query at least two of the plurality of healthcare-related knowledge graphs based on at least the one or more healthcare-related keywords in the received keyword-based query. In order to retrieve the set of healthcare-related response sub-graphs from the plurality of healthcare-related knowledge graphs, the graph processor 204 may be configured to identify the one or more nodes of one or more healthcare-related graphs in each of the plurality of healthcare-related knowledge graphs. The one or more nodes are identified based on their association with the one or more keywords. Hereinafter, the identified one or more nodes corresponding to each of the plurality of healthcare-related knowledge graphs have been referred to as content nodes.

Further, in an embodiment, the graph processor 204 may store the content nodes corresponding to each of the plurality of healthcare-related knowledge graphs in the memory 210 by use of an inverted index methodology. Thereafter, the graph processor 204 may retrieve the set of healthcare-related response sub-graphs from each of the plurality of healthcare-related knowledge graphs based on the corresponding content nodes. In an exemplary scenario, the retrieval process for retrieving the set of healthcare-related response sub-graphs from each of the plurality of healthcare-related knowledge graphs (these steps are repeated for each knowledge graph in parallel) is described below.

Firstly, the graph processor 2024 may track the content nodes in each of the plurality of healthcare-related knowledge graphs. These content nodes generally occur as cliques in each of the plurality of healthcare-related knowledge graphs. The main computation in this step is to identify such cliques corresponding to each of the plurality of healthcare-related knowledge graphs. Thereafter, for each content node corresponding to each of the plurality of healthcare-related knowledge graphs, the graph processor 204 may be further configured to identify one or more possible connections with one or more other content nodes in the inverted index to determine one or more pairs of content nodes. The identification of each pair of content nodes is based on a distance between the nodes in each pair of the content nodes. The distance between each pair of content nodes, which is represented by the shortest distance between them in a healthcare-related knowledge graph, is constrained to be less than a pre-specified threshold value. Thereafter, for each of the plurality of healthcare-related knowledge graphs, the graph processor 204 may be further configured to construct the cliques with nodes as content nodes and edges representing the shortest distances between each pair of content nodes. The graph processor 204 may only consider the cliques containing the content nodes that span over the one or more healthcare-related keywords. However, it may be necessary to observe the manner in which such content nodes appear and their connections in each of the plurality of healthcare-related knowledge graphs. Therefore, the graph processor 204 may convert the cliques corresponding to each of the plurality of healthcare-related knowledge graphs to Steiner trees using approaches known in the art, for example, based on the computation of minimum spanning tree and replacement of the resulting edges with the respective shortest paths. These Steiner trees corresponding to each of the plurality of healthcare-related knowledge graphs represent the set of healthcare-related response sub-graphs corresponding to each of the plurality of healthcare-related knowledge graphs retrieved as a result of the received keyword-based query. After retrieving the set of healthcare-related response sub-graphs from each of the plurality of healthcare-related knowledge graphs, the graph processor 204, in conjunction with the transceiver 212, may store the set of healthcare-related response sub-graphs corresponding to each of the plurality of healthcare-related knowledge graphs in the storage device, such as the memory 210 or the database server 104.

At step 308, the first set of healthcare-related ranked sub-graphs is generated corresponding to each of the plurality of healthcare-related knowledge graphs. In an embodiment, the rank generating processor 206 may be configured to generate the first set of healthcare-related ranked sub-graphs corresponding to each of the plurality of healthcare-related knowledge graphs. In an embodiment, the first set of healthcare-related ranked sub-graphs is generated based on ranking of healthcare-related response sub-graphs in the set of healthcare-related response sub-graphs. In an embodiment, the ranking is based on at least content and structure information associated with each of the set of healthcare-related response sub-graphs. In an embodiment, the structure-based ranking utilizes the structure of a healthcare-related response sub-graph. For example, how “close” the plurality of nodes of the healthcare-related response sub-graph are to each other i.e., closer the plurality of nodes to each other, higher the rank of the healthcare-related response sub-graph. In an embodiment, the content-based ranking utilizes the information present in the plurality of nodes and the one or more edges of the healthcare-related response sub-graph and uses information retrieval techniques known in the art to evaluate the rank of the healthcare-related response sub-graph. In an exemplary scenario, the ranking process for ranking the healthcare-related response sub-graphs in the set of healthcare-related response sub-graphs retrieved from each of the plurality of healthcare-related knowledge graphs is described below.

Firstly, based on the received keyword-based query and the content information associated with the plurality of nodes and the one or more edges, the rank generating processor 206 may be configured to determine a weight for each edge in each of the set of healthcare-related response sub-graphs. Thereafter, the rank generating processor 206 may rank each healthcare-related response sub-graph in the set of healthcare-related response sub-graphs based on the structural information associated with each healthcare-related response sub-graph, i.e., the rank generating processor 206 may compute the shortest distance between each and every node in the plurality of nodes associated with the healthcare-related response sub-graph. The sum of the computed distances represents a rank score of the healthcare-related response sub-graph. Similarly, the rank generating processor 206 may determine the rank score of the remaining healthcare-related response sub-graphs in the set of healthcare-related response sub-graphs. Based on the determined rank scores, the rank generating processor 206 may rank the healthcare-related response sub-graphs in the set of healthcare-related response sub-graphs to generate the first set of healthcare-related ranked sub-graphs corresponding to each of the plurality of healthcare-related knowledge graphs. After generating the first set of healthcare-related ranked sub-graphs corresponding to each of the plurality of healthcare-related knowledge graphs, the rank generating processor 206 may store the first set of healthcare-related ranked sub-graphs in the storage device, such as the memory 210 or the database server 104.

At step 310, the set of healthcare-related connected sub-graphs is generated. In an embodiment, the graph generating processor 208 may be configured to generate the set of healthcare-related connected sub-graphs. In an embodiment, the graph generating processor 208 may generate a healthcare-related connected sub-graph that corresponds to the set of healthcare-related connected sub-graphs based on at least a healthcare-related ranked sub-graph in the first set of healthcare-related ranked sub-graphs associated with at least two of the plurality of healthcare-related knowledge graphs. In an embodiment, the healthcare-related connected sub-graph is generated based on at least a degree of alignment of the healthcare-related ranked sub-graph in the first set of healthcare-related ranked sub-graphs associated with a healthcare-related knowledge graph in the plurality of healthcare-related knowledge graphs with the healthcare-related ranked sub-graph in the first set of healthcare-related ranked sub-graphs associated with one or more remaining healthcare-related knowledge graphs in the plurality of healthcare-related knowledge graphs. The degree of alignment is determined based on at least degree of similarities between each pair of nodes. A first node in each pair of nodes is associated with the healthcare-related ranked sub-graph in the first set of healthcare-related ranked sub-graphs associated with the healthcare-related knowledge graph in the plurality of healthcare-related knowledge graphs. A second node in each pair of nodes is associated with the healthcare-related ranked sub-graph in the first set of healthcare-related ranked sub-graphs associated with the one or more remaining healthcare-related knowledge graphs in the plurality of healthcare-related knowledge graphs.

In an exemplary scenario, the graph generating processor 208 may utilize one or more known algorithms known in the art, for example, an IsoRank algorithm, to determine the degree of alignment between two or more healthcare-related ranked sub-graphs. In first stage, the graph generating processor 208 may be configured to determine a first similarity score between each pair of nodes in the two or more healthcare-related ranked sub-graphs. The graph generating processor 208 may determine the first similarity score based on an iterative computation of similarity between their neighborhood topologies using one or more algorithms known in the art, for example, a Power Method (PM) algorithms. Let the first similarity score between all pairs of nodes in the two or more healthcare-related ranked sub-graphs be denoted as “R”. The computations involved may be shown as follows:

R=AR (1)

where,

the value of “R” represents principal eigenvector of “A”; and

“A” indicates the support provided to each node-pair due to matching between their respective neighboring.

Further, in second stage, the graph generating processor 208 may be configured to determine a second similarity score between each pair of nodes highlighting the node-to-node semantic similarity between them. The graph generating processor 208 may utilize Wikipedia® and WordNet® semantic similarity measures to determine the second similarity score. The eigenvalue equation (denoted by equation-1) is modified to account for the node-to-node semantic similarity score (i.e., the second similarity score) as shown below:

R=αAR+(1−α)E (2)

where,

α corresponds to a tuning parameter that controls weight of similarity score involving neighborhood topologies of each pair of nodes, relative to that of node-to-node semantic similarity measures between each pair of nodes. Further, the value of α is limited by 0≤α≤1.

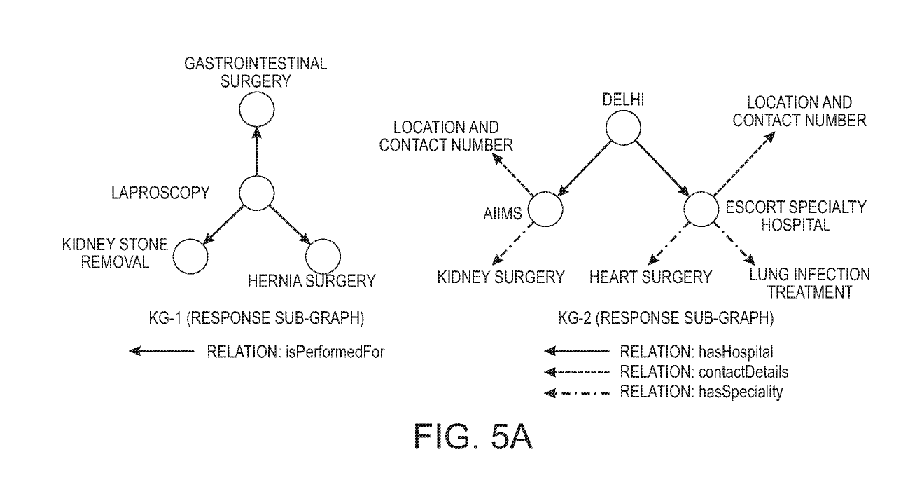

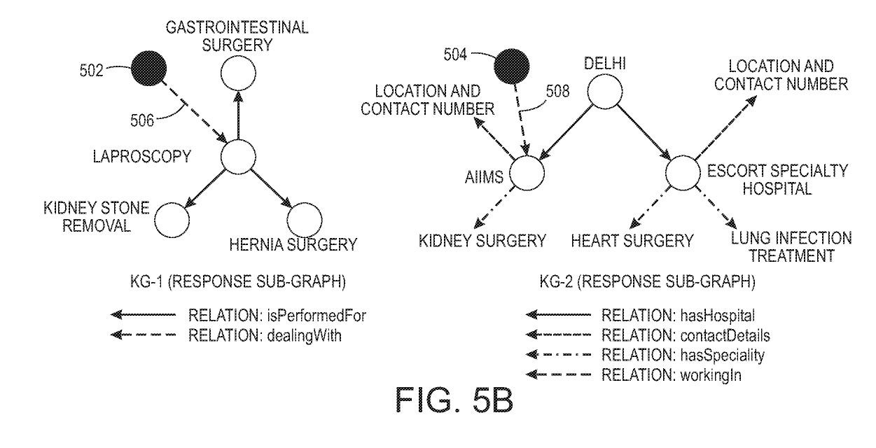

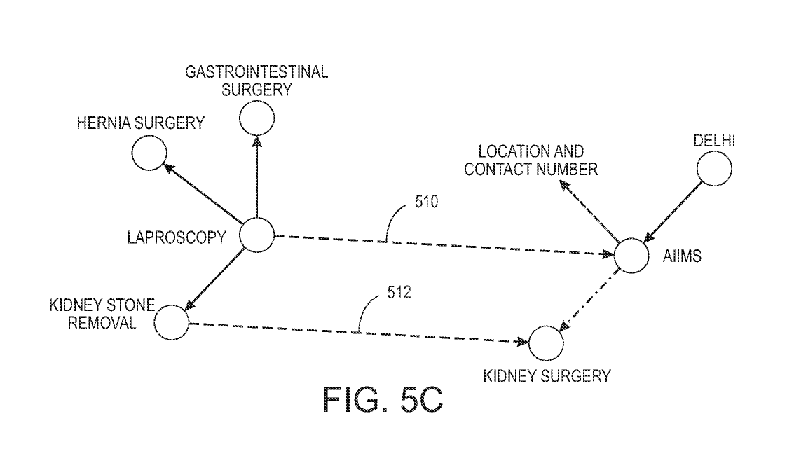

Further, in third stage, the graph generating processor 208 may be configured to extract one-to-one node-node mapping based on the “R” scores computed between the pairs of nodes belonging to the two or more healthcare-related ranked sub-graphs. Further, the graph generating processor 208 may utilize a modified greedy algorithm based on bipartite graph-matching to obtain the one-to-one node-node mapping or a global alignment between the two or more healthcare-related ranked sub-graphs. Thereafter, a common healthcare-related sub graph (i.e., the connected healthcare-related sub-graph) is generated from the resulting global alignment. After generating the set of healthcare-related connected sub-graphs, the graph generating processor 208 may store the set of healthcare-related connected sub-graphs in the storage device, such as the memory 210 or the database server 104. The generation of the healthcare-related connected sub-graph has been described later in detail in conjunction with FIG. 5. In another exemplary scenario, the healthcare-related connected sub-graph may be generated based on exact matching between nodes. In yet another exemplary scenario, the healthcare-related connected sub-graph may be generated based on based on external knowledge databases in addition to the exact matching between nodes.

At step 312, the second set of healthcare-related ranked sub-graphs is generated. In an embodiment, the rank generating processor 206 may be configured to generate the second set of healthcare-related ranked sub-graphs. In an embodiment, the second set of healthcare-related ranked sub-graphs is generated based on ranking of healthcare-related connected sub-graphs in the set of healthcare-related connected sub-graphs. In an embodiment, the ranking of the healthcare-related connected sub-graphs in the set of healthcare-related connected sub-graphs is based on at least an aggregated ranking of a third set of healthcare-related ranked sub-graphs, a fourth set of healthcare-related ranked sub-graphs, and a fifth set of healthcare-related ranked sub-graphs.

In an embodiment, the rank generating processor 206 may be configured to generate the third set of healthcare-related ranked sub-graphs by ranking the healthcare-related connected sub-graphs in the set of healthcare-related connected sub-graphs based on at least the received keyword-based query. The rank generating processor 206 may determine a query alignment score of each of the set of healthcare-related connected sub-graphs. The query alignment score of the healthcare-related connected graph is determined based on the determined degree of alignment associated with the healthcare-related connected sub-graphs. Based on the query alignment score, the rank generating processor 206 may rank the healthcare-related connected sub-graphs in the set of healthcare-related connected sub-graphs to generate the third set of healthcare-related ranked sub-graphs.

Further, in an embodiment, the rank generating processor 206 may generate the fourth set of healthcare-related ranked sub-graphs. The fourth set of healthcare-related ranked sub-graphs may be generated based on ranking of the healthcare-related connected sub-graphs in the set of healthcare-related connected sub-graphs. The ranking of the healthcare-related connected sub-graphs is based on at least the content and structure information associated with each of the plurality of nodes and each of the one or more edges in each of the set of healthcare-related connected sub-graphs, as discussed above in step 308.

Further, in an embodiment, the rank generating processor 206 may generate the fifth set of healthcare-related ranked sub-graphs by ranking the healthcare-related connected sub-graphs in the set of healthcare-related connected sub-graphs based on at least an alignment quality score of each of the set of healthcare-related connected sub-graphs. The alignment quality score of the healthcare-related connected sub-graph is determined based on at least a count of connected nodes and/or connected edges in the healthcare-related connected sub-graph. Based on the alignment quality score, the rank generating processor 206 may rank the healthcare-related connected sub-graphs in the set of healthcare-related connected sub-graphs to generate the fifth set of healthcare-related ranked sub-graphs.

Thereafter, the rank generating processor 206 may generate the second set of healthcare-related ranked sub-graphs based on at least the aggregated ranking of the third set of healthcare-related ranked sub-graphs, the fourth set of healthcare-related ranked sub-graphs, and the fifth set of healthcare-related ranked sub-graphs. The rank generating processor 206 may utilize one or more rank aggregation algorithms known in the art, for example, Kemeny-Young rank aggregation method, to obtain the aggregated ranking of the third set of healthcare-related ranked sub-graphs, the fourth set of healthcare-related ranked sub-graphs, and the fifth set of healthcare-related ranked sub-graphs.

At step 314, the one or more queried responses are render on the user interface displayed on the display screen of the requestor-computing device 102. In an embodiment, the processor 202 may be further configured to render the one or more queried responses on the user interface displayed on the display screen of the requestor-computing device 102 over the communication network 108. In an embodiment, the processor 202 may render the one or more queried responses based on a selection of one or more of the generated second set of healthcare-related ranked sub-graphs. For example, the processor 202 may render the top ranked healthcare-related sub-graphs in the generated second set of healthcare-related ranked sub-graphs. In another exemplary scenario, the processor 202 may render the top two ranked healthcare-related sub-graphs from the generated second set of healthcare-related ranked sub-graphs. Control passes to end step 316.

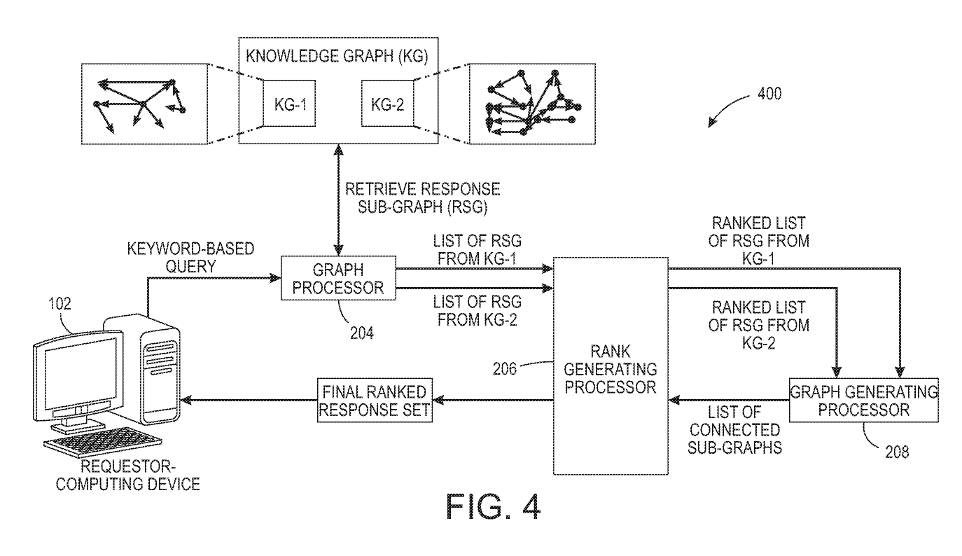

FIG. 4 is a block diagram that illustrates an exemplary workflow for content processing to query multiple knowledge graphs, in accordance with an embodiment. With reference to FIG. 4, there is shown an exemplary workflow 400 that is described in conjunction with FIG. 1, FIG. 2, and FIG. 3.

In an embodiment, the graph processor 204 may receive the keyword-based query comprising the one or more keywords from the requestor-computing device 102 over the communication network 108. Based on the received keyword-based query, the graph processor 204 may further query the plurality of knowledge graphs (e.g., KG-1 and KG-2 in FIG. 4) to retrieve response sub-graphs (RSG). After retrieving the set of response sub-graphs (e.g., a list of RSG from KG-1 and a list of RSG from KG-2 in FIG. 4), the graph processor 204 may transmit the set of response sub-graphs (e.g., the list of RSG from KG-1 and the list of RSG from KG-2 in FIG. 4) to the rank generating processor 206. Further, the rank generating processor 206 may be configured to generate the ranked list of sub-graphs (e.g., a ranked list of RSG from KG-1 and a ranked list of RSG from KG-2 in FIG. 4). Further, the rank generating processor 206 may transmit the ranked list of sub-graphs (e.g., the ranked list of RSG from KG-1 and the ranked list of RSG from KG-2 in FIG. 4) to the graph generating processor 208. The graph generating processor 208 may be configured to generate a list of connected sub-graphs that is further transmitted to the rank generating processor 206. The rank generating processor 206 may be configured to generate a final ranked response set based on the ranking of the connected sub-graphs in the list of connected sub-graphs. The processor 202, in conjunction with the transceiver 212, (not shown in FIG. 4) may render one or more of the final ranked response set on the user interface displayed on the display screen of the requestor-computing device 102 over the communication network 108.

FIGS. 5A, 5B, and 5C are line-node diagrams that illustrates a generation of a connected sub-graph, in accordance with an embodiment. In an illustrative example, consider a healthcare-related knowledge graph (KG) that is associated with various surgical treatments for a number of ailments or diseases. The healthcare-related knowledge graph (KG) includes nodes and edges. The nodes represent either a surgical treatment or a disease and the edges represent various relations, such as Isperformedfor' between the nodes, representing a triple, such as “X-surgical-treatment isperformedfor Y-disease”.

Though, a single healthcare-related knowledge graph may not have all the information required to answer a query, such as “laparoscopy surgery delhi”, it may require fetching healthcare-related response sub-graphs (i.e., Steiner trees) from multiple healthcare-related knowledge graphs (KGs), such as KG-1 and KG-2 as shown in FIG. 5A. In response to the query, a queried response is then obtained by joining the healthcare-related response sub-graphs that have been obtained after querying each of the healthcare-related knowledge graphs (KGs). The queried response may be obtained based on the identification of commonalities/alignments between multiple healthcare-related response sub-graphs and joining them accordingly. In order to do this, firstly, each of the healthcare-related response sub-graphs representing the answer snippets are expanded as shown in FIG. 5B. In FIG. 5B, the expanded edges and nodes have been shown with dotted lines (denoted by 506 and 508) and black nodes (502 and 504), respectively. The IsoRank algorithm (known in the art) may be used to determine the best mapping between a pair of healthcare-related response sub-graphs, covering all the nodes in the healthcare-related response sub-graphs.

As discussed above in step 310, the first similarity score (i.e., neighbourhood topology matching score) “R” and the second similarity score (i.e., the node-to-node semantic similarity score) “E” are computed for all pairs of nodes in the expanded healthcare-related response sub-graphs. The matching between the nodes “Doctor's name” in both the healthcare-related response sub-graphs (result in high value of “R”) contributing towards the matching of a pair of nodes “Laparoscopy” and “AIIMS”. Further, the semantic relatedness “E” between “Kidney Stone Removal” and “Kidney Surgery” aid in matching between the nodes of the pair. Thereafter, an overall score Rₒᵥₑᵣₐₗₗ is computed with suitable weights applied to each of the computed score, i.e., “R” and “E”, respectively. Finally, a one-to-one mapping or alignment, using Rₒᵥₑᵣₐₗₗ scores, may be obtained using methods mentioned in the third stage of step 310. The alignment is shown with dotted lines (denoted by 510 and 512 in FIG. 5C). The alignment may suggest the queried healthcare-related response that “AIIMS is the place in Delhi, where laparoscopy surgery is done”. The alignment quality is obtained by the computation of the size of the largest connected component in the alignment. This is evaluated by the calculation of the total number of nodes/edges in the alignment.

The disclosed embodiments encompass numerous advantages. The disclosure provides a method and a system for content processing to query multiple knowledge graphs. The disclosed method and system further facilitates an end-to-end querying of the multiple knowledge graphs based on a keyword-based query comprising one or more keywords of interest to a user. The keyword-based query may not require the user to have an expertise knowledge. Further, the disclosed method and system enhances upon efficiency and accuracy of queried responses by use of joining or connecting of multiple responses from the multiple knowledge graphs.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive, such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, DOS', ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for content processing to query multiple healthcare-related knowledge graphs. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person having ordinary skill in the art will appreciate that the systems, modules, and sub-modules have been illustrated and described to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for content processing, by a computing server, to query multiple healthcare-related knowledge graphs, said method comprising:
retrieving, by a graph processor at said computing server, a set of healthcare-related response sub-graphs from each of a plurality of healthcare-related knowledge graphs based on one or more healthcare-related keywords in a keyword-based query received from a requestor-computing device over a communication network, wherein said plurality of healthcare-related knowledge graphs are communicatively coupled with one or more medical databases over said communication network;
generating, by a rank generating processor at said computing server, a first set of healthcare-related ranked sub-graphs corresponding to each of said plurality of healthcare-related knowledge graphs;
generating, by a graph generating processor at said computing server, a set of healthcare-related connected sub-graphs, wherein a healthcare-related connected sub-graph in said set of healthcare-related connected sub-graphs is generated based on at least a healthcare-related ranked sub-graph in said first set of healthcare-related ranked sub-graphs associated with said plurality of healthcare-related knowledge graphs;
generating, by said rank generating processor, a second set of healthcare-related ranked sub-graphs based on at least a ranking of healthcare-related connected sub-graphs in said set of healthcare-related connected sub-graphs; and
rendering, by a processor, a queried response, based on a selection of one or more of said generated second set of healthcare-related ranked sub-graphs, on a user interface displayed on a display screen of said requestor-computing device.

2. The method of claim 1, wherein each of said retrieved set of healthcare-related response sub-graphs comprises at least a plurality of nodes and one or more edges between said plurality of nodes, wherein each of said plurality of nodes corresponds to one or more entities defined by said one or more healthcare-related keywords in said received keyword-based query, and wherein each of said one or more edges between two nodes in said plurality of nodes corresponds to a relationship between said one or more entities associated with each of said two nodes.

3. The method of claim 2, wherein said first set of healthcare-related ranked sub-graphs corresponding to each of said plurality of healthcare-related knowledge graphs is generated based on a ranking of healthcare-related sub-graphs in said retrieved set of healthcare-related response sub-graphs, wherein said ranking is based on at least content and structure information associated with each of said plurality of nodes and each of said one or more edges in each of said retrieved set of healthcare-related response sub-graphs.

4. The method of claim 1, wherein said healthcare-related connected sub-graph is generated based on at least a degree of alignment of said healthcare-related ranked sub-graph in said first set of healthcare-related ranked sub-graphs associated with a healthcare-related knowledge graph in said plurality of healthcare-related knowledge graphs with said healthcare-related ranked sub-graph in said first set of healthcare-related ranked sub-graphs associated with one or more remaining healthcare-related knowledge graphs in said plurality of healthcare-related knowledge graphs.

5. The method of claim 4, wherein said degree of alignment is determined based on at least degree of similarities between each pair of nodes, wherein a first node in said each pair of nodes is associated with said healthcare-related ranked sub-graph in said first set of healthcare-related ranked sub-graphs associated with said healthcare-related knowledge graph in said plurality of healthcare-related knowledge graphs, and wherein a second node in said each pair of nodes is associated with said healthcare-related ranked sub-graph in said first set of healthcare-related ranked sub-graphs associated with said one or more remaining healthcare-related knowledge graphs in said plurality of healthcare-related knowledge graphs.

6. The method of claim 1, wherein said ranking of said healthcare-related connected sub-graphs in said set of healthcare-related connected sub-graphs is based on at least an aggregated ranking of a third set of healthcare-related ranked sub-graphs, a fourth set of healthcare-related ranked sub-graphs, and a fifth set of healthcare-related ranked sub-graphs.

7. The method of claim 6, wherein said third set of healthcare-related ranked sub-graphs is generated, by said rank generating processor, based on said ranking of said healthcare-related connected sub-graphs in said set of healthcare-related connected sub-graphs, wherein said healthcare-related connected sub-graphs in said set of healthcare-related connected sub-graphs are ranked based on at least said received keyword-based query.

8. The method of claim 6, wherein said fourth set of healthcare-related ranked sub-graphs is generated, by said rank generating processor, based on said ranking of said healthcare-related connected sub-graphs in said set of healthcare-related connected sub-graphs, wherein said healthcare-related connected sub-graphs in said set of healthcare-related connected sub-graphs are ranked based on at least content and structure information associated with each of a plurality of nodes and each of one or more edges in said each of said set of healthcare-related connected sub-graphs.

9. The method of claim 6, wherein said fifth set of healthcare-related ranked sub-graphs is generated, by said rank generating processor, based on said ranking of said healthcare-related connected sub-graphs in said set of healthcare-related connected sub-graphs, wherein said healthcare-related connected sub-graphs in said set of healthcare-related connected sub-graphs are ranked based on at least an alignment quality score of each of said healthcare-related connected sub-graphs, where said alignment quality score of said healthcare-related connected sub-graph is determined based on at least a count of connected nodes and/or connected edges in said healthcare-related connected sub-graph.

10. A system for content processing to query multiple healthcare-related knowledge graphs, said system comprising:
a graph processor configured to retrieve a set of healthcare-related response sub-graphs from each of a plurality of healthcare-related knowledge graphs based on one or more healthcare-related keywords in a keyword-based query received from a requestor-computing device over a communication network, wherein said plurality of healthcare-related knowledge graphs are communicatively coupled with one or more medical databases over said communication network;
a rank generating processor configured to generate a first set of healthcare-related ranked sub-graphs corresponding to each of said plurality of healthcare-related knowledge graphs;
a graph generating processor configured to generate a set of healthcare-related connected sub-graphs, wherein a healthcare-related connected sub-graph in said set of healthcare-related connected sub-graphs is generated based on at least a healthcare-related ranked sub-graph in said first set of healthcare-related ranked sub-graphs associated with said plurality of healthcare-related knowledge graphs;
said rank generating processor configured to generate a second set of healthcare-related ranked sub-graphs based on at least a ranking of healthcare-related connected sub-graphs in said set of healthcare-related connected sub-graphs; and
a processor configured to render a queried response, based on a selection of one or more of said generated second set of healthcare-related ranked sub-graphs, on a user interface displayed on a display screen of said requestor-computing device.

11. The system of claim 10, wherein each of said retrieved set of healthcare-related response sub-graphs comprises at least a plurality of nodes and one or more edges between said plurality of nodes, wherein each of said plurality of nodes corresponds to one or more entities defined by said one or more healthcare-related keywords in said received keyword-based query, and wherein each of said one or more edges between two nodes in said plurality of nodes corresponds to a relationship between said one or more entities associated with each of said two nodes.

12. The system of claim 11, wherein said first set of healthcare-related ranked sub-graphs corresponding to each of said plurality of healthcare-related knowledge graphs is generated based on a ranking of healthcare-related sub-graphs in said retrieved set of healthcare-related response sub-graphs, wherein said ranking is based on at least content and structure information associated with each of said plurality of nodes and each of said one or more edges in each of said retrieved set of healthcare-related response sub-graphs.

13. The system of claim 10, wherein said healthcare-related connected sub-graph is generated based on at least a degree of alignment of said healthcare-related ranked sub-graph in said first set of healthcare-related ranked sub-graphs associated with a healthcare-related knowledge graph in said plurality of healthcare-related knowledge graphs with said healthcare-related ranked sub-graph in said first set of healthcare-related ranked sub-graphs associated with one or more remaining healthcare-related knowledge graphs in said plurality of healthcare-related knowledge graphs.

14. The system of claim 13, wherein said graph generating processor is configured to determine said degree of alignment based on at least degree of similarities between each pair of nodes, wherein a first node in said each pair of nodes is associated with said healthcare-related ranked sub-graph in said first set of healthcare-related ranked sub-graphs associated with said healthcare-related knowledge graph in said plurality of healthcare-related knowledge graphs, and wherein a second node in said each pair of nodes is associated with said healthcare-related ranked sub-graph in said first set of healthcare-related ranked sub-graphs associated with said one or more remaining healthcare-related knowledge graphs in said plurality of healthcare-related knowledge graphs.

15. The system of claim 10, wherein said ranking of said healthcare-related connected sub-graphs in said set of healthcare-related connected sub-graphs is based on at least an aggregated ranking of a third set of healthcare-related ranked sub-graphs, a fourth set of healthcare-related ranked sub-graphs, and a fifth set of healthcare-related ranked sub-graphs.

16. The system of claim 15, wherein said rank generating processor is configured to generate said third set of healthcare-related ranked sub-graphs based on said ranking of said healthcare-related connected sub-graphs in said set of healthcare-related connected sub-graphs, wherein said healthcare-related connected sub-graphs in said set of healthcare-related connected sub-graphs are ranked based on at least said received keyword-based query.

17. The system of claim 15, wherein said rank generating processor is configured to generate said fourth set of healthcare-related ranked sub-graphs based on said ranking of said healthcare-related connected sub-graphs in said set of healthcare-related connected sub-graphs, wherein said healthcare-related connected sub-graphs in said set of healthcare-related connected sub-graphs are ranked based on at least content and structure information associated with each of a plurality of nodes and each of one or more edges in said each of said set of healthcare-related connected sub-graphs.

18. The system of claim 15, wherein said rank generating processor is configured to generate said fifth set of healthcare-related ranked sub-graphs based on said ranking of said healthcare-related connected sub-graphs in said set of healthcare-related connected sub-graphs, wherein said healthcare-related connected sub-graphs in said set of healthcare-related connected sub-graphs are ranked based on at least an alignment quality score of each of said healthcare-related connected sub-graphs, where said alignment quality score of said healthcare-related connected sub-graph is determined based on at least a count of connected nodes and/or connected edges in said healthcare-related connected sub-graph.

19. A method for content processing, by a computing server, to query multiple knowledge graphs, said method comprising:
retrieving, by a graph processor at said computing server, a set of response sub-graphs from each of a plurality of knowledge graphs based on one or more keywords in a keyword-based query received from a requestor-computing device over a communication network;
generating, by a rank generating processor at said computing server, a first set of ranked sub-graphs corresponding to each of said plurality of knowledge graphs;
generating, by a graph generating processor at said computing server, a set of connected sub-graphs, wherein a connected sub-graph in said set of connected sub-graphs is generated based on at least a ranked sub-graph in said first set of ranked sub-graphs associated with said plurality of knowledge graphs;
generating, by said rank generating processor, a second set of ranked sub-graphs based on at least a ranking of connected sub-graphs in said set of connected sub-graphs; and
rendering, by a processor, a queried response, based on a selection of one or more of said generated second set of ranked sub-graphs, on a user interface displayed on a display screen of said requestor-computing device.

20. The method of claim 19, wherein each of said retrieved set of response sub-graphs comprises at least a plurality of nodes and one or more edges between said plurality of nodes, wherein each of said plurality of nodes corresponds to one or more entities defined by said one or more keywords in said received keyword-based query, and wherein each of said one or more edges between two nodes in said plurality of nodes corresponds to a relationship between said one or more entities associated with each of said two nodes.

21. The method of claim 20, wherein said first set of ranked sub-graphs corresponding to each of said plurality of knowledge graphs is generated based on a ranking of sub-graphs in said retrieved set of response sub-graphs, wherein said ranking is based on at least content and structure information associated with each of said plurality of nodes and each of said one or more edges in each of said retrieved set of response sub-graphs.

22. The method of claim 19, wherein said connected sub-graph is generated based on at least a degree of alignment of said ranked sub-graph in said first set of ranked sub-graphs associated with a knowledge graph in said plurality of knowledge graphs with said ranked sub-graph in said first set of ranked sub-graphs associated with one or more remaining knowledge graphs in said plurality of knowledge graphs.

23. The method of claim 22, wherein said degree of alignment is determined based on at least degree of similarities between each pair of nodes, wherein a first node in said each pair of nodes is associated with said ranked sub-graph in said first set of ranked sub-graphs associated with said knowledge graph in said plurality of knowledge graphs, and wherein a second node in said each pair of nodes is associated with said ranked sub-graph in said first set of ranked sub-graphs associated with said one or more remaining knowledge graphs in said plurality of knowledge graphs.

24. The method of claim 19, wherein said ranking of connected sub-graphs in said set of connected sub-graphs is based on at least an aggregated ranking of a third set of ranked sub-graphs, a fourth set of ranked sub-graphs, and a fifth set of ranked sub-graphs.

25. The method of claim 24, wherein said third set of ranked sub-graphs is generated, by said rank generating processor, based on said ranking of connected sub-graphs in said set of connected sub-graphs based on at least said received keyword-based query.

26. The method of claim 24, wherein said fourth set of ranked sub-graphs is generated, by said rank generating processor, based on said ranking of connected sub-graphs in said set of connected sub-graphs based on at least content and structure information associated with each of a plurality of nodes and each of one or more edges in said each of said set of connected sub-graphs.

27. The method of claim 24, wherein said fifth set of ranked sub-graphs is generated, by said rank generating processor, based on said ranking of connected sub-graphs in said set of connected sub-graphs based on at least an alignment quality score of each of said set of connected sub-graphs, where said alignment quality score of said connected sub-graph is determined based on at least a count of connected nodes and/or connected edges in said connected sub-graph.

28. system for content processing to query multiple knowledge graphs, said system comprising:
a graph processor configured to retrieve a set of response sub-graphs from each of a plurality of knowledge graphs based on one or more keywords in a keyword-based query received from a requestor-computing device over a communication network;
a rank generating processor configured to generate a first set of ranked sub-graphs corresponding to each of said plurality of knowledge graphs;
a graph generating processor configured to generate a set of connected sub-graphs, wherein a connected sub-graph in said set of connected sub-graphs is generated based on at least a ranked sub-graph in said first set of ranked sub-graphs associated with said plurality of knowledge graphs;
said rank generating processor configured to generate a second set of ranked sub-graphs based on at least a ranking of connected sub-graphs in said set of connected sub-graphs; and
a processor configured to a queried response, based on a selection of one or more of said generated second set of ranked sub-graphs, on a user interface displayed on a display screen of said requestor-computing device.

29. A computer program product for use with a computer, said computer program product comprising a non-transitory computer readable medium, wherein said non-transitory computer readable medium stores a computer program code for content processing to query multiple healthcare-related knowledge graphs, wherein said computer program code is executable by one or more processors in a computing device to:
retrieve a set of response healthcare-related sub-graphs from each of a plurality of healthcare-related knowledge graphs based on one or more healthcare-related keywords in a keyword-based query received from a requestor-computing device over a communication network, wherein said plurality of healthcare-related knowledge graphs are communicatively coupled with one or more medical databases over said communication network;
generate a first set of healthcare-related ranked sub-graphs corresponding to each of said plurality of healthcare-related knowledge graphs;
generate a set of healthcare-related connected sub-graphs, wherein a healthcare-related connected sub-graph in said set of healthcare-related connected sub-graphs is generated based on at least a healthcare-related ranked sub-graph in said first set of healthcare-related ranked sub-graphs associated with said plurality of healthcare-related knowledge graphs;
generate a second set of healthcare-related ranked sub-graphs based on at least a ranking of healthcare-related connected sub-graphs in said set of healthcare-related connected sub-graphs; and
render a queried response, based on a selection of one or more of said generated second set of healthcare-related ranked sub-graphs, on a user interface displayed on a display screen of said requestor-computing device.
